(19) United States
(12) Patent Application Publication
(10) Pub. No.: US 2018/0010445 A1
(43) Pub. Date: Jan. 11, 2018

(54) Systems and Methods for Wellbore Logging to Adjust for Downhole Clock Drift

(71) Applicant: Halliburton Energy Services, Inc., Houston, TX (US)

(72) Inventors: Andrew Andrew COOPER, Humble, TX (US); Arthur Chuen Hon CHENG, Houston, TX (US)

(73) Assignee: Halliburton Energy Services, Inc., Houston, TX (US)

(21) Appl. No.: 15/307,736

(22) PCT Filed: Dec. 17, 2015
(86) PCT No.: PCT/US2015/066379

§ 371 Date: Oct. 28, 2016

(51) Int. Cl. E21B 47/12; H04L 7/00

(52) U.S. Cl. CPC E21B 47/12; H04L 7/0008

(57) ABSTRACT

A method for logging a wellbore includes positioning a downhole tool having a downhole clock in the wellbore, logging the wellbore with the downhole tool, transmitting a surface signal from a wellbore surface to the downhole tool, and receiving the surface signal at the downhole tool. The method also includes transmitting a downhole signal from the downhole tool to the surface, receiving the downhole signal at the wellbore surface, and determining clock drift based on an arrival time of the surface signal at the downhole tool and an arrival time of the downhole signal at the wellbore surface.

### BACKGROUND

This section is intended to introduce the reader to various aspects of art that may be related to various aspects of the presently described embodiments. This discussion is believed to be helpful in providing the reader with background information to facilitate a better understanding of the various aspects of the described embodiments. Accordingly, it should be understood that these statements are to be read in this light and not as admissions of prior art.

In oil and gas industries, many types of sensors are used to measure phenomena related to subsurface properties (e.g., density, conductivity, porosity, and resistivity, among others) to evaluate subsurface conditions. These measurements can be performed after a borehole has been drilled, using a wireline tool, for example, or simultaneously with the drilling of the borehole, e.g., logging-while-drilling (LWD) or measurement-while-drilling (MWD).

Some downhole measurements rely on precise synchronization between surface clocks and downhole clocks. In some instances, when using a surface clock and a downhole clock, the time of the downhole clock may drift relative to the time of the surface clock, which could affect the quality of the downhole measurements.

### BRIEF DESCRIPTION OF DRAWINGS

For a detailed description of the embodiments of the invention, reference will now be made to the accompanying drawings in which:

FIG. 1 shows an illustrative oilfield environment in accordance with one or more embodiments of the present disclosure;

FIGS. 2A and 2B show systems for determining clock drift in accordance with one or more embodiments of the present disclosure;

FIG. 3 shows a computer with which one or more embodiments of the present disclosure may be implemented.

### DETAILED DESCRIPTION

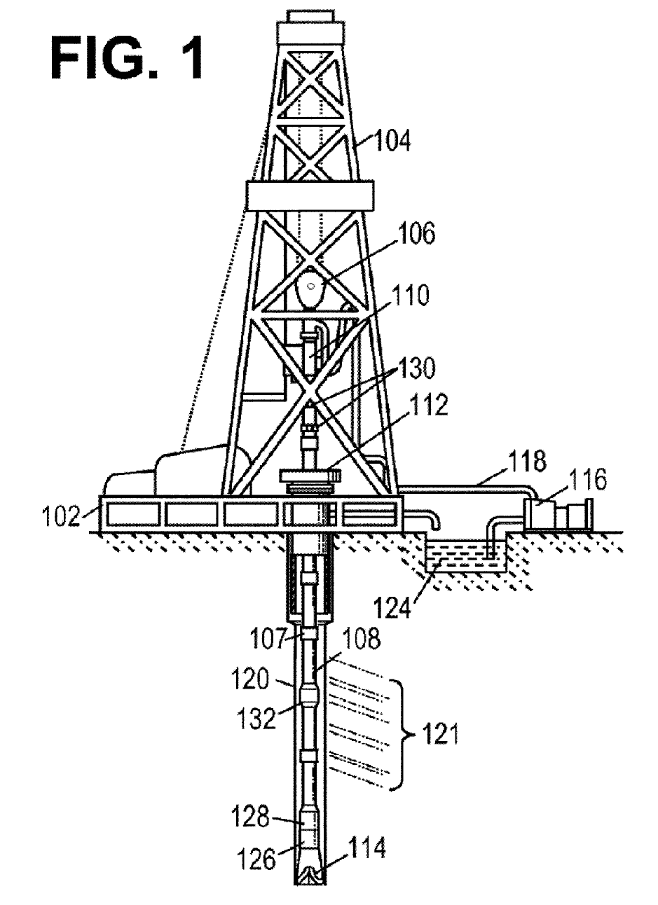

Referring now to the present figures, FIG. 1 shows an illustrative oilfield environment. A drilling platform 102 is equipped with a derrick 104 that supports a hoist 106 for raising and lowering a drill string 108. The hoist 106 suspends a top drive 110 that rotates the drill string 108 as the drill string is lowered through the well head 112. Sections of the drill string 108 are connected by threaded connectors 107. Connected to the lower end of the drill string 108 is a drill bit 114. As bit 114 rotates, a borehole 120 is created that passes through various formations 121 within a reservoir. A pump 116 circulates drilling fluid through a supply pipe 118 to top drive 110, through the interior of drill string 108, through orifices in drill bit 114, back to the surface via the annulus around drill string 108, and into a retention pit 124. The drilling fluid transports cuttings from the borehole 120 into the pit 124 and aids in maintaining the integrity of the borehole 120.

Downhole sensors (including tool 126) may be coupled to a telemetry module 128 having a transmitter (e.g., acoustic telemetry transmitter) that transmits signals in the form of acoustic vibrations in the tubing wall of drill string 108. A receiver array 130 may be coupled to tubing below the top drive 110 to receive transmitted signals. One or more repeater modules 132 may be optionally provided along the drill string to receive and retransmit the telemetry signals. Other telemetry techniques may be employed including mud pulse telemetry, electromagnetic telemetry, and wired drill pipe telemetry. Many telemetry techniques also offer the ability to transfer commands from the surface to the tool 126, thereby enabling adjustment of tool configuration and operating parameters. In some embodiments, the telemetry module 128 also or alternatively stores measurements for later retrieval when the tool 126 returns to the surface.

The tool 126 in this embodiment may be integrated into the bottom-hole assembly near the bit 114. The tool 126 may take the form of a drill collar, i.e., a thick-walled tubular that provides weight and rigidity to aid the drilling process. As the bit 114 extends the borehole 120 through the formations 121, the tool 126 collects measurements of the borehole and formation around the tool 126, as well as measurements of the tool orientation and position, drilling fluid properties, and various other drilling conditions. In one or more embodiments, the tool 126 may be a logging tool, an induction tool, or any other tool known to those of skill in the art. It should also be appreciated that while FIG. 1 illustrates a drilling environment, the disclosure may also be used in an LWD capacity.

The tool 126 may acquire data relating to the borehole, the drill string, the surrounding formation, the operation(s) being performed, and various other conditions. One type of data acquisition technique uses sound waves, also referred to as seismic or acoustic waves, to measure subsurface properties. These systems may include a source and a receiver and may also include a memory and a calculating device for storing and processing sound waves. In one or more embodiments, seismic waves may include a frequency range of about 10 Hz to about 200 Hz, sonic waves may include a frequency range of about 2 kHz to about 20 kHz, and ultrasonic waves may include a frequency range of about 250 kHz to about 500 kHz.

In one or more embodiments, the source may be operated to produce seismic signals that propagate through the subsurface and are detected by a receiver. Seismic signals detected by the receiver may be characterized in terms of frequency, amplitude, and speed of propagation. These characteristics, along with the transit and/or arrival times of the signals from the source to the receiver through the subsurface, may be used to provide information relating to subsurface properties.

In one or more embodiments, clocks, chronometers, or other timing devices, may be used to determine the elapsed time between the time at which the seismic signals were produced and the time at which the seismic signals were detected by the receiver. When using independent clocks, such as a first clock at a first location (e.g., the surface, in the drill string, along the borehole, etc.) and a second clock at a second location (e.g., downhole, in the drill string, along the borehole, within a downhole tool, etc.), the second clock may be located in a borehole for extended periods of time. In some instances, the longer the period of time the second clock is located in a borehole, the greater the second clock drifts, or changes, relative the first clock. As the drift between the first clock and the second clock lengthens, the more uncertain measurements obtained using the downhole tool become. The degree of drift between the clocks may be affected by many factors including calibration errors, clock accuracy, clock design (housing materials, temperature control, shock resistance, etc.), and exposure to harsh conditions (e.g., high temperatures, vibrations, high pressures, etc.), among others.

Accordingly various tools, systems, and methods are disclosed to log wellbores while also determining clock drift. In addition, various tools, systems, and methods are disclosed to adjust for clock drift and/or to synchronize two or more clocks for performing logging operations. In one or more embodiments, a first clock may be located near or at the surface of a borehole (or any other location known in the art) and a second clock may be located downhole (e.g., in the drill string, at a distal end of the drill string, in a bottom-hole assembly, along the borehole wall, among many other locations).

One or more embodiments include transmitting a signal from a surface clock to a downhole clock and transmitting a signal from the downhole clock tool to the surface. Although transmission is discussed between two clocks, transmission may occur between multiple clocks at any locations in an oilfield environment, or may even occur between a clock at a well site and a remote clock located off site. Based on transmission and/or arrival times, clock drift may be determined and used to synchronize two or more clocks. The determined clock drift may also be used to adjust data acquired by a tool or a tool component positioned within a borehole that measures parameters of the rock formations around the borehole and the fluids contained within them.

In one or more embodiments, a tool may be provided with a clock that continuously and/or intermittently monitors time. The tool may also be provided with one or more transmitters and one or more receivers for transmitting and receiving signals. The tool may be coupled to a drill string that may include one or more additional tools and/or components. In some embodiments, a determination unit and/or a synchronization unit may be used to determine clock drift and synchronize two or more clocks. The determination unit and/or the synchronization unit may be operable using a computer having a processor, memory, one or more input devices, and/or one or more output devices.

In some embodiments, one or more clocks may be included in one or more components. One or more transmitters may be included in one or more components and transmission may be performed using one or more transmitters that correspond to one or more clocks. Similarly, one or more receivers may be included in one or more components and reception may be performed using one or more receivers that correspond to one or more clocks. For example, a logging tool may be located at a distal end of a borehole and may include a transmitter and a receiver configured to communicate (i.e., transmit and receive signals) with a surface unit. A timing unit located at a surface of the borehole may include a transmitter and a receiver configured to communicate (i.e., transmit and receive signals) with the logging tool and components of the logging tool.

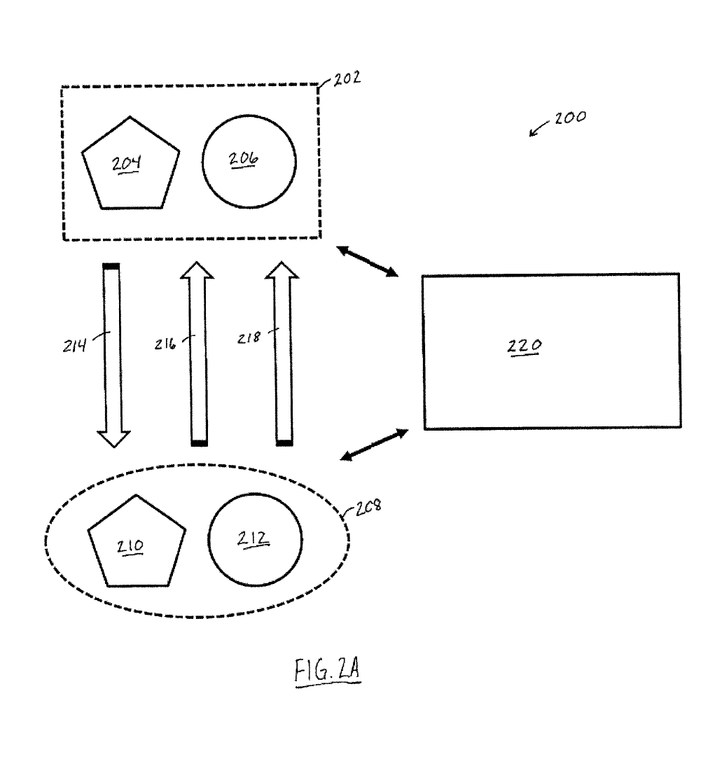

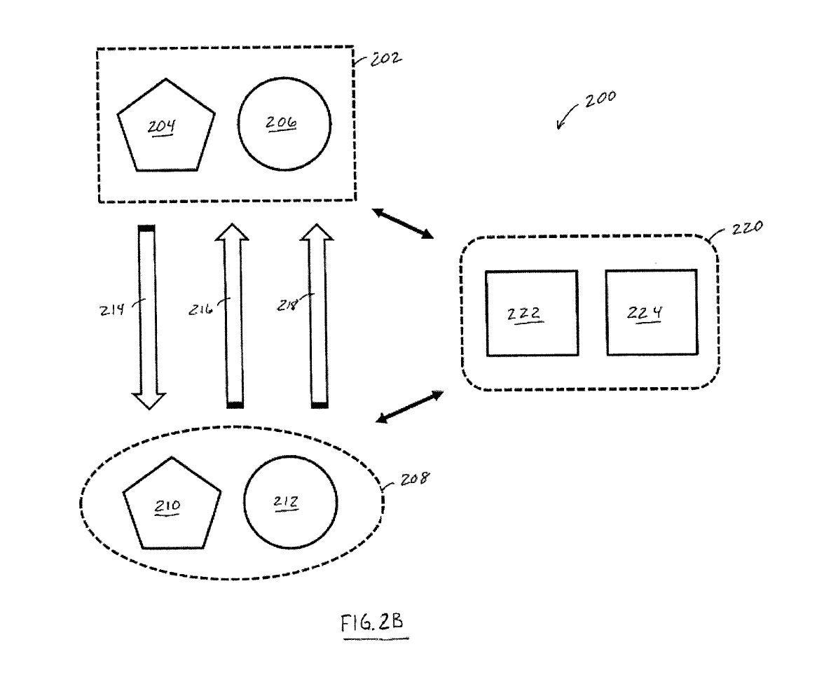

Referring now to FIGS. 2A and 2B, a system 200 for determining clock drift is shown. The system 200 includes a surface clock 202 having a surface transmitter 204 and a surface receiver 206. The surface clock 202 may be located at a surface location (e.g., at a borehole surface) and/or may be included in one or more components. Although shown as a single unit in FIGS. 2A and 2B, the surface clock 202, the surface transmitter 204, and the surface receiver 206 may be separate units. The surface clock 202 may include only one of the surface transmitter 204 and the surface receiver 206. In some embodiments, the surface transmitter 204 and the surface receiver 206 may be a single unit, such as a transceiver, for example. Those having ordinary skill in the art would appreciate that many other components and configurations may be considered without departing from the scope of the present disclosure.

In one or more embodiments, the surface clock 202 may be capable of communicating with a downhole clock 208. The downhole clock 208 may be included in one or more components and/or may be located at a location different from the location of the surface clock 202 (e.g., within a borehole). As shown in FIG. 2A, the downhole clock 208 includes a downhole transmitter 210 and a downhole receiver 212 and may be capable of communicating with the surface clock 202. Similar to the above, although shown as a single unit in FIGS. 2A and 2B, the downhole clock 208, the downhole transmitter 210, and the downhole receiver 212 may be separate units. The downhole clock 208 may include one of the downhole transmitter 210 and the downhole receiver 212. In some embodiments, the downhole transmitter 210 and the downhole receiver 212 may be a single unit, such as a transceiver, for example. Those having ordinary skill in the art would appreciate that many other components and configurations may be considered without departing from the scope of the present disclosure.

Initially, the surface clock 202 and the downhole clock 208 may be synchronized so that the time read by each clock is the same. In other embodiments, the surface clock 202 and the downhole clock 208 may be calibrated to read within a given time difference of one another. Over time, for reasons mentioned above, among others, the time of the downhole clock 208 may drift relative to the time of the surface clock 202. In order to adjust for, or otherwise limit, the effect of the drift, the system 200 may determine the clock drift (i.e., the time difference between the surface clock and the downhole clock). Thereafter, the clock drift may be used to adjust one of the surface clock and the downhole clock, synchronize the surface clock 202 and the downhole clock 208, and/or adjust data obtained using a tool that performs measurements based on time recorded by the surface clock 202 and/or the downhole clock 208.

To determine the clock drift, a surface transmitter 204 may transmit a surface signal 214 to the downhole receiver 212. The surface signal 214 may be transmitted along a symmetric communication channel. A symmetric communication channel refers to a communication channel in which transit time of a signal transmitted between two locations in one direction is the same as transit time of a signal transmitted between the same two locations in the opposite direction. For example, when using a symmetric communication channel to send data from a surface location downhole to a downhole location, the one-way transit time is the same as the transit time when data is sent uphole from the downhole location to the surface location.

The surface signal 214 may be transmitted via the symmetric communication channel using one or more transmission techniques known in the art. For example, the surface signal 214 may be transmitted using mud-pulse telemetry, where pressure pulses may be sent along a mud column in the borehole. Another technique for transmitting the surface signal 214 may be through electromagnetic (EM) telemetry, where EM radiation may be sent through a formation. Acoustic telemetry may also be used to transmit the surface signal 214 in which the drill string itself acts as the medium of communication and vibrations or other acoustic signals may be sent along the drill string from one location to another. Of course, other transmission and communication techniques may be used without departing from the scope of the present disclosure.

In one or more embodiments, the surface signal 214 may be transmitted at a predetermined time. For example, the surface signal 214 may be transmitted relative to a drilling event (e.g., surface integral minute after pumps-down, after a steering system activates, etc.). The surface signal may be transmitted at a fixed interval (e.g., every hour, every day, every 15 minutes, every 5 minutes, or other intervals).

The surface signal 214 may be received by the downhole receiver 212. The downhole receiver 212 may detect or determine a data sequence encoded within the surface signal 214. For example, when using mud-pulse telemetry, the surface signal 214 may include a series of pulses having different relative positions. The relative positions and number of pulses may be transmitted as the surface signal 214 and detected by the downhole receiver 212. The arrival time of the surface signal 214 at the downhole receiver 212 may be determined and/or recorded.

In one or more embodiments, the particular sequence may be predetermined and/or known by the downhole receiver 212. If the sequence is known, a cross correlation between the received surface signal 214 and the expected (i.e., known) sequence may be performed in order to determine an arrival time of the surface signal 214 at the downhole receiver 212. For example, cross-correlation techniques such as Time Delay Estimation (TDE) and Time Delay Of Arrival (TDOA) may be used to determine an arrival time of the surface signal 214 at the downhole receiver. In one or more embodiments, an inverse relationship between a sequence length and the time estimate may be used to determine the sequence length for sufficient time estimation. For example, to determine an arrival time accurate to within less than 1 ms, a sequence with a length between about 2 second to about 10 seconds may be utilized. For higher precision, a sequence with a length greater than 10 seconds may be utilized, such as sequence lengths of 30 seconds, one minute, or two minutes.

After receiving the surface signal 214 and determining an arrival time of the surface signal 214 at the downhole receiver 212, the downhole transmitter 210 may transmit a downhole signal 216 to the surface clock 202. As above, the downhole signal 216 may be transmitted along a symmetric communication channel using mud-pulse telemetry, EM telemetry, acoustic telemetry, or any other communication techniques known in the art.

In one or more embodiments, the downhole signal 216 may be transmitted at a particular time. For example, the downhole signal 216 may be transmitted at a fixed time relative to the arrival time of the surface signal 214 at the downhole receiver 212 (e.g., a next integer minute after arrival of the surface signal 214). In some embodiments, the downhole signal 216 may be transmitted at a fixed internal relative the arrival time (e.g., one minute, two minutes, or three minutes after arrival of the surface signal 214). Those having ordinary skill in the art would appreciate that other times and/or intervals may be considered without departing from the scope of the present disclosure.

The downhole signal 216 may include a data sequence different from or the same as the surface signal 214. In one or more embodiments, the downhole signal 216 may be received by the surface receiver 206. The surface receiver 206 may detect or determine the data sequence encoded within the downhole signal 216 and the arrival time of the downhole signal 216 at the surface receiver 206 may be determined and/or recorded. In one or more embodiments, the sequence may be predetermined and/or known by the surface receiver 206. If the sequence is known, a cross correlation between the received downhole signal 216 and the expected (i.e., known) sequence may be performed in order to determine an arrival time of the downhole signal 216 at the surface receiver 206. As above, cross-correlation techniques such as Time Delay Estimation (TDE) and Time Delay of Arrival (TDOA) may be used to determine an arrival time of the surface signal 214 at the downhole receiver. In one or more embodiments, an inverse relationship between a sequence length and the time estimate may be used to determine the sequence length for sufficient time estimation. For example, to determine an arrival time accurate to within less than 1 ms, a sequence with a length between about 2 second to about 10 seconds may be utilized. For higher precision, a sequence with a length greater than 10 seconds may be utilized, such as sequence lengths of 30 seconds, one minute, or two minutes.

As shown, after receiving the surface signal 214 and determining an arrival time of the surface signal 214 at the downhole receiver 212, the downhole transmitter 210 may transmit an arrival time signal 218 to the surface clock 202. Alternatively, after receiving the downhole signal 216 and determining an arrival time of the downhole signal 216 at the surface receiver 206, the surface transmitter 204 may transmit an arrival time signal to the downhole clock 208.

Using the arrival time of the surface signal 214 at the downhole receiver 212 as read by the downhole clock 208, and the arrival time of the downhole signal 216 at the surface receiver 206 as read by the surface clock 202, clock drift between the surface clock 202 and the downhole clock 208 may be determined. The clock drift may be determined using a determination unit 220, which may be configured to record and/or store arrival times, determine clock drift, synchronize clocks, and/or adjust acquired data based on clock drift. The determination unit 220 may include a computer system, as described below, or any other computation or calculating unit known in the art.

The determination unit 220 may capable of communicating with one or more clocks and may be located at or near the location of a surface clock (e.g., at a borehole surface), the location of a downhole clock (e.g., downhole), or a remote site. In addition, one or more determination units may be included in the system 200 and/or in one or more components of the system 200. The determination units 220 may be configured to communicate with one another. For example, the surface clock 202 may include a determination unit, the downhole clock 208 may include a determination unit, and a determination unit may also be included at a remote site.

The determination unit 220 may also include a synchronizer 222 and a storage unit 224, as shown in FIG. 2B. Although shown included in the determination unit 220, the synchronizer 222 and the storage unit 224 may be separate units. The synchronizer 222, the storage unit 224, the determination unit 220, and other components and/or clocks of the system 200 may be configured to communicate with one another. In one or more embodiments, the synchronizer 222 may be configured to synchronize one or more clocks. For example, the synchronizer 222 may adjust a time of the surface clock 202 and/or the downhole clock 208 to synchronize the clocks such the time of the surface clock 202 and the time of the downhole clock 208 are the same. The synchronizer 222 may adjust the time based on the clock drift as determined by the determination unit 220. In some embodiments, each clock may include an associated synchronizer 222 communicable with one or more components that may be used to adjust and/or synchronize two or more clocks.

As mentioned above, the system 200 and/or the determination unit 220 may include a storage unit 224. The storage unit 224 may be configured to store arrival times of signals transmitted between two or more clocks, such as the surface clock 202 and the downhole clock 208. In some embodiments, the storage unit 224 may store and/or record the clock drift between the surface clock 202 and the downhole clock 208, or any number of clocks for example. The storage unit 224 may be configured to store a series of clock drifts determined over time. Using the series of clock drifts, data acquired by a downhole tool may be adjusted. For example, a clock drift adjustment or function may be applied to data acquired over time read by one of the surface clock 202 and the downhole clock 208.

In one or more embodiments, a mathematical example of a clock drift determination may be as follows. Although a surface clock and a downhole clock are discussed below, those having ordinary skill would appreciate that embodiments of the present disclosure may include clocks located at any location in an oilfield environment and/or near or within any tools known in the art. Further, although the example below describes only two clocks, clock drift may be determined between three or more clocks at different locations and/or three or more clocks at any locations may be synchronized without departing from the scope of the present disclosure.

TABLE 1

| Action | Surface Clock | Downhole Clock |
|---|---|---|
| Transmit signal downhole | t₀ | t₀ + ε |
| Receive signal downhole | t₀ + Δ | t₀ + ε + Δ |
| Transmit signal to surface | t₁ − ε | t₁ |
| Receive signal at surface | t₁ − ε + Δ | t₁ + Δ |

Referring to Table 1, a downhole clock time has drifted from a surface clock time by ε. In one or more embodiments, ε may be positive, negative, or zero. Due to the clock drift, ε, at the time of transmission of the signal downhole, the surface clock time reads t₀, while the downhole clock time reads t₀+ε. By defining the signal transmission time as Δ, the downhole signal receipt time is t₀+Δ, as read by the surface clock, while the downhole signal receipt time is t₀+ε+Δ, as read by the downhole clock. In one or more embodiments, t₀, t₁, and δ are known and tₐₛ and t_{ad} are measured. When Δ in canceled (or calculated, as discussed below), ε remains as the only unknown, which is calculable based on the equations discussed below.

Once the signal transmitted downhole is received at the downhole clock, a signal may be transmitted to the surface at time t₁, according to the downhole clock. Again, due to the clock drift, the surface clock time reads t₁−ε when the signal is transmitted to the surface. The time, t₁, may be predetermined, may be based on the arrival time of receipt of the signal downhole, and/or may be based on an event, as described above. As the signal transmission time is again Δ (due to the symmetry of the transmission channel), the time of receipt of the signal to the surface as read by the surface clock is t₁−ε+Δ, while the downhole clock reads t₁+Δ.

Thereafter, the time of arrival of the signal downhole as read by the downhole clock may be transmitted to the surface to determine the clock drift, ε. Alternatively, or in addition, the time of arrival of the signal to surface as read by the surface clock may be transmitted downhole to determine the clock drift, ε. In some embodiments, both the time of arrival of the signal downhole as read by the downhole clock and the time of arrival of the signal to surface as read by the surface clock may be transmitted to determine the clock drift, ε, using a determination unit, for example.

To determine the clock drift, ε, the difference between the arrival time of the signal downhole according to the downhole clock and the arrival time of the signal to the surface according to the surface clock may be calculated as follows:

tₐₛ−t_{ad}=t₁−t₀−2ε

where tₐₛ is the arrival time of the signal to the surface according to the surface clock, t_{ad} is the arrival time of the signal downhole according to the downhole clock, t₁ is the transmit time of the downhole signal according to the downhole clock, t₀ is the transmit time of the surface signal according to the surface clock, and ε is the clock drift.

In one or more embodiments, transmission time of the signal to the surface may be performed at a fixed interval after receiving the downhole signal. To illustrate, in Table 2 below, a downhole clock time has drifted from a surface clock time by ε. As above, due to the clock drift, ε, at the time of transmission of the signal downhole, the surface clock time reads t₀, while the downhole clock time reads t₀+ε. By defining the signal transmission time as Δ, the downhole signal receipt time is t₀+Δ, as read by the surface clock, while the downhole signal receipt time is t₀+ε+Δ, as read by the downhole clock.

TABLE 2

| Action | Surface Clock | Downhole Clock |
|---|---|---|
| Transmit signal downhole | t₀ | t₀ + ε |
| Receive signal downhole | t₀ + Δ | t₀ + ε + Δ |
| Transmit signal to surface | t₀ + Δ + δ | t₀ + ε + Δ + δ |
| Receive signal at surface | t₀ + 2Δ + δ | t₀ + ε + 2Δ + δ |

Once the signal transmitted downhole is received at the downhole clock, a signal may be transmitted to the surface at time fixed time interval, δ, after receiving the signal transmitted downhole. Thus, according to the downhole clock, transmission of a signal to the surface occurs at t₀+ε+Δ+δ, while the surface clock reads t₀+Δ+δ. As the signal transmission time is Δ, the time of receipt of the signal to the surface as read by the surface clock is t₀+2Δ+δ, while the downhole clock reads t₀+ε+2Δ+δ.

Thereafter, the time of arrival of the signal downhole as read by the downhole clock may be transmitted to the surface to determine the clock drift, ε. Alternatively, or in addition, the time of arrival of the signal to surface as read by the surface clock may be transmitted downhole to determine the clock drift, ε. In some embodiments, both the time of arrival of the signal downhole as read by the downhole clock and the time of arrival of the signal to surface as read by the surface clock may be transmitted to determine the clock drift, ε, using a determination unit, for example.

From the arrival time of the signal at the surface, because t₀ and δ are known, Δ may be calculated as follows:

tₐₛ=t₀+2Δ+δ

where tₐₛ is the arrival time of the signal to the surface according to the surface clock, t₀ is the transmit time of the surface signal according to the surface clock, and δ is the fixed time interval.

Now that Δ is determined, the clock drift, ε, may be calculated as follows:

t_{ad}=t₀+ε+Δ

where t_{ad} is the arrival time of the signal downhole according to the downhole clock, t₀ is the transmit time of the surface signal according to the surface clock, and Δ is the signal transmission time calculated above.

In the above, system latency was not included in the calculations. As this will not be the case in some embodiments, a surface calibration of the system may be carried out immediately after synchronizing the clocks at surface before running in hole and starting drilling. At this time, the clocks will agree to a high-degree of precision; ε can be calculated similar to the above, and any non-zero value of ε may be included in the calculations as being attributed to system latency. Calibration and system latency calculations may be performed in any embodiment of the present disclosure.

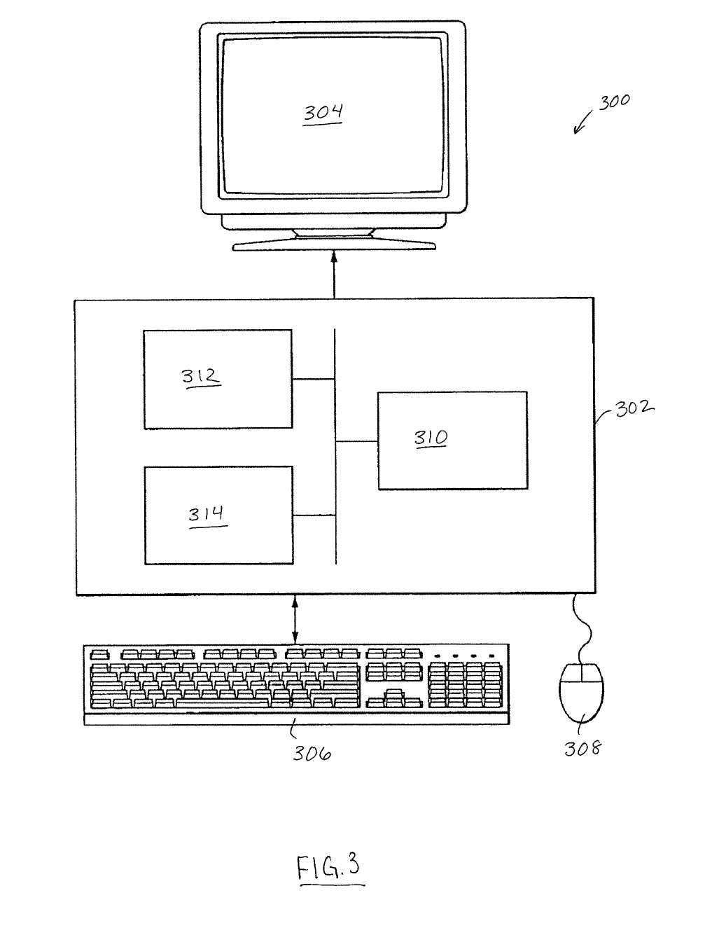

Some embodiments of the present disclosure relate to systems and methods for determining and adjusting for clock drift. A system in accordance with embodiments of the present disclosure may be implemented on a stand-alone computer or a downhole computer that is included on a tool. FIG. 3 shows a general purpose computer that may be used with embodiments of the invention.

Referring now to FIG. 3, FIG. 3 shows a general purpose computer that may be used with embodiments of the invention. As shown in FIG. 3, a general computer system 300 may include a main unit 302, a display 304 and input devices such as a keyboard 306 and a mouse 308. The main unit 500 may include a central processor unit (CPU) 310, a permanent memory 312 (e.g., a hard disk), and a random access memory (RAM) 314. The memory 312 may include a program that includes instructions for performing the methods of the invention, which may be performed by the CPU 310, the permanent memory 312, and/or the RAM 314. A program may be embodied on any computer retrievable medium, such as a hard disk, a diskette, a CD-ROM, or any other medium known or yet to be developed. The programming may be accomplished with any programming language and the instructions may be in a form of a source codes that may need compilation before the computer can execute the instructions or in a compiled (binary) or semi-compiled codes. The precise form and medium the program is on are not germane to the invention and should not limit the scope of the invention.

In addition to the embodiments described above, many examples of specific combinations are within the scope of the disclosure, some of which are detailed below:

### Example 1

A method for logging a wellbore, the method including positioning a downhole tool including a downhole clock in the wellbore, logging the wellbore with the downhole tool, transmitting a surface signal from a wellbore surface to the downhole tool, receiving the surface signal at the downhole tool, transmitting a downhole signal from the downhole tool to the surface, receiving the downhole signal at the wellbore surface, determining clock drift based on an arrival time of the surface signal at the downhole tool and an arrival time of the downhole signal at the wellbore surface.

### Example 2

The method of Example 1, in which transmitting the surface signal includes performing transmission of a data sequence from the wellbore surface to the downhole tool using at least one of mud-pulse telemetry, electromagnetic telemetry, and acoustic telemetry.

### Example 3

The method of Example 1, in which transmitting the downhole signal includes transmitting a data sequence from the downhole tool to the wellbore surface using at least one of mud-pulse telemetry, electromagnetic telemetry, and acoustic telemetry.

### Example 4

The method of Example 1, in which transmitting the surface signal and transmitting the downhole signal include transmitting using a symmetric communication channel.

### Example 5

The method of Example 1, further including transmitting the downhole signal at a given time after the arrival time of the surface signal.

### Example 6

The method of Example 1, further including transmitting the downhole signal about one minute after the arrival time of the surface signal at the downhole tool or about one minute after transmitting the surface signal from the wellbore surface to the downhole tool.

### Example 7

The method of Example 1, in which determining the clock drift includes comparing the arrival time of the surface signal recorded by the downhole clock and the arrival time of the downhole signal recorded by a surface clock.

### Example 8

The method of Example 1, further including transmitting the arrival time of the surface signal at the downhole tool to the wellbore surface, and in which determining the clock drift includes determining a difference between the arrival time of the surface signal according to the downhole clock and the arrival time of the downhole signal according to a surface clock.

### Example 9

The method of Example 1, further including adjusting at least one of the downhole clock and a surface clock based on the clock drift, and logging the wellbore with the downhole tool after adjusting.

### Example 10

The method of Example 1, further including adjusting measurements obtained by the downhole tool during logging based on the clock drift.

### Example 11

A method of logging a wellbore, the method including logging the wellbore with a downhole tool, transmitting a surface signal from a surface to the downhole tool, receiving a downhole signal from the downhole tool at the surface, determining the clock drift based on an arrival time of the surface signal at the downhole tool and an arrival time of the downhole signal at the surface, adjusting data acquired by the downhole tool based on the clock drift, and synchronizing a downhole clock and a surface clock based on the clock drift.

### Example 12

The method of Example 11, in which determining clock drift includes comparing the arrival time of the surface signal as recorded by a downhole clock and the arrival time of the downhole signal as recorded by a surface clock.

### Example 13

The method of Example 11, in which synchronizing includes at least one of adjusting the downhole clock to correspond with the surface clock and adjusting the surface clock to correspond with the downhole clock.

### Example 14

The method of Example 11, further including receiving the arrival time of the surface signal from the downhole tool at the surface, and in which determining the clock drift includes calculating a difference between the arrival time of the downhole signal according to a surface clock and the arrival time of the surface signal according to a downhole clock.

### Example 15

The method of Example 9, in which determining the clock drift includes calculating the clock drift based on:

tₐₛ−t_{ad}=t₁−t₀−2ε

where tₐₛ is the arrival time of the downhole signal according to a surface clock, t_{ad} is the arrival time of the downhole signal according to a downhole clock, t₁ is a transmit time of the downhole signal, t₀ is a transmit time of the surface signal, and ε is the clock drift.

### Example 16

A system for logging a wellbore, the system including a surface transmitter configured to transmit a surface signal from a surface location to a downhole location, a downhole transmitter configured to transmit a downhole signal from the downhole location to the surface location, a surface clock configured to record an arrival time of the downhole signal at the surface location, a downhole clock configured to record an arrival time of the surface signal at the downhole location, and a determination unit configured to determine a clock drift between the downhole clock and the surface clock based on the arrival time of the downhole signal and the arrival time of the surface signal, and

a logging tool configured to log the wellbore based on the clock.

### Example 17

The system of Example 16, in which the arrival time of the downhole signal at the surface location is determined by performing a cross-correlation of the downhole signal with an expected signal.

### Example 18

The system of Example 16, in which the arrival time of the surface signal at the downhole location is determined by performing a cross-correlation of the surface signal with an expected signal.

### Example 19

The system of Example 16, in which the determination unit is configured to calculate the clock drift based on:

tₐₛ=t₀+2Δ+δ

and

t_{ad}=t₀+ε+Δ

where tₐₛ is the arrival time of the downhole signal according to a surface clock, t_{ad} is the arrival time of the downhole signal according to a downhole clock, t₀ is a transmit time of the surface signal, δ is a fixed time interval, Δ is a signal transmission time, and ε is the clock drift.

### Example 20

The system of Example 16, further including a synchronizer configured to synchronize the downhole clock and the surface clock, and in which the synchronization includes at least one of adjusting the downhole clock to correspond with the surface clock and adjusting the surface clock to correspond with the downhole clock.

This discussion is directed to various embodiments of the invention. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to intimate that the scope of the disclosure, including the claims, is limited to that embodiment.

Certain terms are used throughout the description and claims to refer to particular features or components. As one skilled in the art will appreciate, different persons may refer to the same feature or component by different names. This document does not intend to distinguish between components or features that differ in name but not function, unless specifically stated. In the discussion and in the claims, the terms “including” and “comprising” are used in an open-ended fashion, and thus should be interpreted to mean “including, but not limited to . . . .” Also, the term “couple” or “couples” is intended to mean either an indirect or direct connection. In addition, the terms “axial” and “axially” generally mean along or parallel to a central axis (e.g., central axis of a body or a port), while the terms “radial” and “radially” generally mean perpendicular to the central axis. The use of “top,” “bottom,” “above,” “below,” and variations of these terms is made for convenience, but does not require any particular orientation of the components.

Reference throughout this specification to “one embodiment,” “an embodiment,” or similar language means that a particular feature, structure, or characteristic described in connection with the embodiment may be included in at least one embodiment of the present disclosure. Thus, appearances of the phrases “in one embodiment,” “in an embodiment,” and similar language throughout this specification may, but do not necessarily, all refer to the same embodiment.

Although the present invention has been described with respect to specific details, it is not intended that such details should be regarded as limitations on the scope of the invention, except to the extent that they are included in the accompanying claims.

We claim:

1. A method for logging a wellbore, the method comprising:
positioning a downhole tool comprising a downhole clock in the wellbore;
logging the wellbore with the downhole tool;
transmitting a surface signal from a wellbore surface to the downhole tool;
receiving the surface signal at the downhole tool;
transmitting a downhole signal from the downhole tool to the surface;
receiving the downhole signal at the wellbore surface;
determining clock drift based on an arrival time of the surface signal at the downhole tool and an arrival time of the downhole signal at the wellbore surface.

2. The method of claim 1, wherein transmitting the surface signal comprises performing transmission of a data sequence from the wellbore surface to the downhole tool using at least one of mud-pulse telemetry, electromagnetic telemetry, and acoustic telemetry.

3. The method of claim 1, wherein transmitting the downhole signal comprises transmitting a data sequence from the downhole tool to the wellbore surface using at least one of mud-pulse telemetry, electromagnetic telemetry, and acoustic telemetry.

4. The method of claim 1, wherein transmitting the surface signal and transmitting the downhole signal comprise transmitting using a symmetric communication channel.

5. The method of claim 1, further comprising transmitting the downhole signal at a given time after the arrival time of the surface signal.

6. The method of claim 1, further comprising transmitting the downhole signal about one minute after the arrival time of the surface signal at the downhole tool or about one minute after transmitting the surface signal from the wellbore surface to the downhole tool.

7. The method of claim 1, wherein determining the clock drift comprises comparing the arrival time of the surface signal recorded by the downhole clock and the arrival time of the downhole signal recorded by a surface clock.

8. The method of claim 1, further comprising:
transmitting the arrival time of the surface signal at the downhole tool to the wellbore surface; and
wherein determining the clock drift comprises determining a difference between the arrival time of the surface signal according to the downhole clock and the arrival time of the downhole signal according to a surface clock.

9. The method of claim 1, further comprising:
adjusting at least one of the downhole clock and a surface clock based on the clock drift; and
logging the wellbore with the downhole tool after adjusting.

10. The method of claim 1, further comprising adjusting measurements obtained by the downhole tool during logging based on the clock drift.

11. A method of logging a wellbore, the method comprising:
logging the wellbore with a downhole tool;
transmitting a surface signal from a surface to the downhole tool;
receiving a downhole signal from the downhole tool at the surface;
determining the clock drift based on an arrival time of the surface signal at the downhole tool and an arrival time of the downhole signal at the surface;
adjusting data acquired by the downhole tool based on the clock drift; and
synchronizing a downhole clock and a surface clock based on the clock drift.

12. The method of claim 11, wherein determining clock drift comprises comparing the arrival time of the surface signal as recorded by a downhole clock and the arrival time of the downhole signal as recorded by a surface clock.

13. The method of claim 11, wherein synchronizing comprises at least one of adjusting the downhole clock to correspond with the surface clock and adjusting the surface clock to correspond with the downhole clock.

14. The method of claim 11, further comprising:
receiving the arrival time of the surface signal from the downhole tool at the surface; and
wherein determining the clock drift comprises calculating a difference between the arrival time of the downhole signal according to a surface clock and the arrival time of the surface signal according to a downhole clock.

15. The method of claim 9, wherein determining the clock drift comprises calculating the clock drift based on:
tₐₛ−t_{ad}=t₁−t₀−2ε
where tₐₛ is the arrival time of the downhole signal according to a surface clock, t_{ad} is the arrival time of the downhole signal according to a downhole clock, t₁ is a transmit time of the downhole signal, t₀ is a transmit time of the surface signal, and ε is the clock drift.

16. A system for logging a wellbore, the system comprising:
a surface transmitter configured to transmit a surface signal from a surface location to a downhole location;
a downhole transmitter configured to transmit a downhole signal from the downhole location to the surface location;
a surface clock configured to record an arrival time of the downhole signal at the surface location;
a downhole clock configured to record an arrival time of the surface signal at the downhole location; and
a determination unit configured to determine a clock drift between the downhole clock and the surface clock based on the arrival time of the downhole signal and the arrival time of the surface signal; and
a logging tool configured to log the wellbore based on the clock.

17. The system of claim 16, wherein the arrival time of the downhole signal at the surface location is determined by performing a cross-correlation of the downhole signal with an expected signal.

18. The system of claim 16, wherein the arrival time of the surface signal at the downhole location is determined by performing a cross-correlation of the surface signal with an expected signal.

19. The system of claim 16, wherein the determination unit is configured to calculate the clock drift based on:
tₐₛ=t₀+2Δ+δ
and
t_{ad}=t₀+ε+Δ
where tₐₛ is the arrival time of the downhole signal according to a surface clock, t_{ad} is the arrival time of the downhole signal according to a downhole clock, t₀ is a transmit time of the surface signal, δ is a fixed time interval, Δ is a signal transmission time, and ε is the clock drift.

20. The system of claim 16, further comprising:
a synchronizer configured to synchronize the downhole clock and the surface clock; and
wherein the synchronization comprises at least one of adjusting the downhole clock to correspond with the surface clock and adjusting the surface clock to correspond with the downhole clock.
